(19) United States
(12) Patent Application Publication
(10) Pub. No.: US 2006/0020993 A1
(43) Pub. Date: Jan. 26, 2006

(54) Advanced set top terminal having a call management feature

(76) Inventors: Sandra A. Hannum, Philadelphia, PA (US); Bruce Bahlmann, Philadelphia, PA (US); James R. Albrecht, Girdwood, AK (US); Bruce R. Bradley, Wayne, PA (US); Matt Wong, Palo Alto, CA (US)

Correspondence Address: MOSER, PATTERSON & SHERIDAN, LLP/;SEDNA PATENT SERVICES, LLC, 595 SHREWSBURY AVENUE, SUITE 100, SHREWSBURY, NJ, 07702, US

(21) Appl. No.: 11/186,914

(22) Filed: Jul. 21, 2005

Related U.S. Application Data
(60) Provisional application No. 60/590,068, filed on Jul. 21, 2004.

(51) Int. Cl. H04N 7/10; H04N 7/173; H04N 7/025

(52) U.S. Cl. 725/111; 725/33; 725/32

(57) ABSTRACT

A system and method providing a call management system adapted for use within a content delivery system.

### RELATED APPLICATIONS

This application claims the benefit of U.S. Provisional Application Ser. No. 60/590,068, filed on Jul. 21, 2004, entitled “Television Processing Methods,” which is incorporated herein by reference in its entirety.

### TECHNICAL FIELD

The invention relates to information distribution systems for providing content to consumer homes and, more particularly, to a call management system adapted for use within such a system.

### BACKGROUND

Television distribution networks such as those of cable television companies are being used to provide telephony services along with television, video, music, broadband and other services. For example, Voice over Internet Protocol (VoIP) services riding on the cable television infrastructure enable various telephony services. Unfortunately, present telephony services do not include all of the call management features that customers desire. Moreover, such services that are offered are insufficiently integrated into the cable television, entertainment-oriented viewing model.

### SUMMARY

Various deficiencies associated with the prior art are addressed by a method for use in an content distribution system, the method comprising:
establishing a call management feature set, the feature set defining functions associated with a call management function; applying a filter rule to a communication, the communication comprising one of an incoming call and an outgoing call; in the case of the communication matching the filter rule, performing one or more actions corresponding to the matched filter rule; wherein at least one of the actions comprises pausing a video presentation in response to the communication.

### DESCRIPTION OF THE DRAWINGS

FIG. 1 depicts a high level block diagram of a television delivery system;

FIG. 2 depicts a high level block diagram of a set top terminal (STT) suitable for use in the television delivery system of FIG. 1;

FIG. 3 depicts a high level block diagram of a portion of an STT adapted to provide bi-directional communications;

FIG. 4 depicts a high level block diagram of a STT modified to include video calling capabilities;

FIG. 5 depicts a graphical depiction of various video conferencing network connections; and

FIGS. 6A-6D together depict a flow diagram of a method according to an embodiment of the invention.

### DETAILED DESCRIPTION

The present invention will be described primarily within the context of a television distribution system, such as a cable television distribution system. However, the invention is applicable to any content distribution system which, in general, distributes video content (e.g., movies, television programming and/or other audiovisual programming) to users or subscribers. Thus, the term “television system” should be broadly construed as including content distribution systems including satellite, cable, telecommunication and other networks capable of performing the functions described herein.

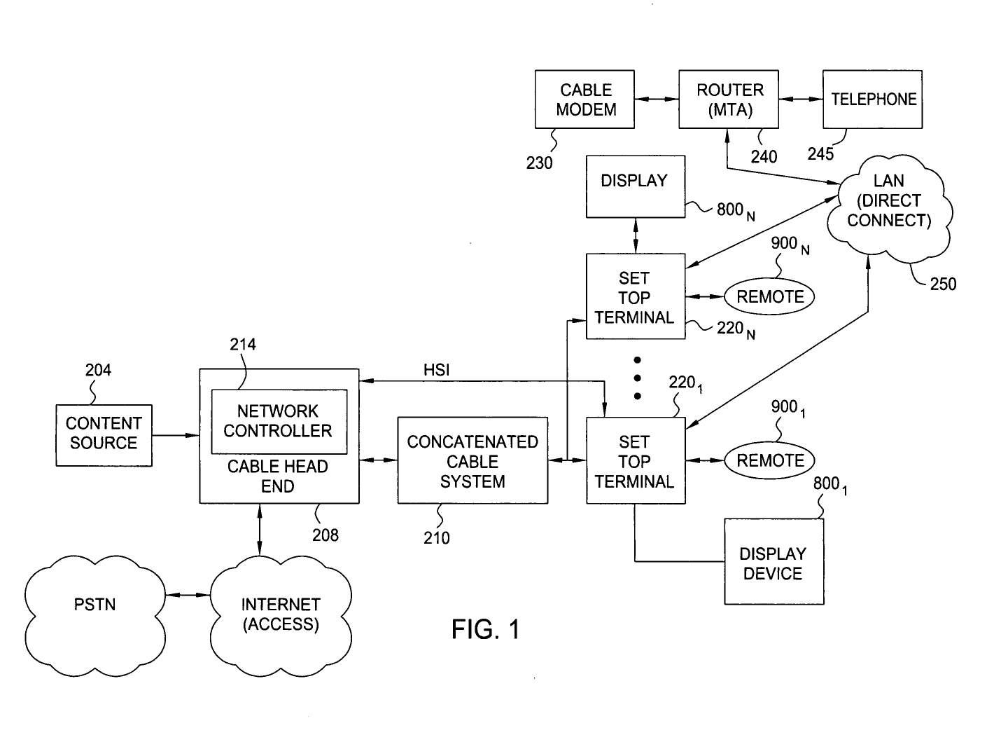

FIG. 1 depicts a high level block diagram of a television delivery system. Specifically FIG. 1 depicts an expanded cable television program delivery system 200 that dramatically increases programming capacity using compressed transmission of television program signals.

The system 200 of FIG. 1 in a basic form uses a program delivery system 200 in conjunction with a conventional concatenated cable television system 210. The program delivery system 200 generally includes a content source 204 where program packaging and control information are created and then assembled in the form of digital data which is compressed, combined/multiplexed, encoded, and mapped into digital signals for transmission to a server, such as cable television headend 208, and a set of in-home decompressors. The program delivery system 200 transports the digital signals to the cable headend 208 via satellite or terrestrial link where the signals are transmitted through a concatenated cable television system 210. Within the cable headend 208, the received signals may be decoded, demultiplexed, managed by a local central distribution and switching mechanism, combined and then transmitted to the set top terminal 220 located in each subscriber's home over the cable system 210.

Although concatenated cable systems 210 are a prevalent transmission media to the home, telephone lines, cellular networks, fiberoptics, Personal Communication Networks, high speed internet connections and similar technology for transmitting to the home can be used with this program delivery system 200.

In a preferred embodiment, the delivery system utilized is in internet protocol (IP) system in which digital video, audio and the like is provided. Using VoIP technology, digital telephony is provided within the context of the cable television system. Specifically, FIG. 1 depicts a high speed internet (HIS) connection between the set top terminals 220 and the head end 208. In addition, the head end 208 is coupled directly to the internet (INTERNET), or coupled to the internet via an access network. In turn, the access network of internet connection cooperates with the public switched telephone network (PSTN) to enable telephony services. That is, the head end 208 supports a telephony function within the set top terminals and/or other telephony devices (not shown) associated with a subscriber.

The delivery system 200 utilizes in-home decompression capability. This capability is performed by a decompressor housed within one or more set top terminal(s) 220 in each subscriber's home. The decompressor remains transparent from the subscriber's point of view and allows any of the compressed signals to be demultiplexed and individually extracted from the composite data stream and then individually decompressed upon selection by the subscriber. The decompressed video signals are converted into analog signals for display via a presentation device, such as a television display or screen. Such analog signals include NTSC formatted signals for use by a standard television standard definition (SDTV) or high definition (HDN) signals for use by a digital television. Control signals are likewise extracted and decompressed and then either executed immediately or placed in local storage such as a RAM. Multiple sets of decompression hardware may be used to decompress video and control signals. The set top terminal 220 may then overlay or combine different signals to form the desired display imagery on the subscriber's presentation device. Graphics on video or picture-on-picture are examples of such a display imagery.

Although a single digital compression standard (e.g., MPEG) may be used for both the program delivery system 200 and the concatenated cable system 210, the compression technique used may differ between the two systems. When the compression standards differ between the two media, the signals received by the cable headend 208 must be decompressed before transmission from the headend 208 to the set top terminals 220. Subsequently, the cable headend 208 must recompress and transmit the signals to the set top terminal 220, which would then decompress the signals using a specific decompression algorithm.

The video signals and program control signals received by the set top terminal 220 correspond to specific television programs and menu selections that each subscriber may access through a subscriber interface. The subscriber interface is a device with buttons located on the set top terminal 220 or on a portable remote control 900. In a preferred embodiment, the set top terminal 220 generates the menus that are displayed on the presentation device by creating arrays of particular menu templates, and the set top terminal 220 displays a specific menu or submenu option for each available video signal.

The cable headend 208 performs two primary functions. First, the cable headend 208 acts as a distribution center, or signal processor, by relaying the program signal to the set top terminal 220 in each subscriber's home. In addition, the cable headend 208 acts as a network controller 214 by receiving information from each set top terminal 220 and passing such information on to an information gathering site such as the operations center 202.

The cable headend 208 provides such signaling capabilities in its dual roles as a signal processor and network controller. As a signal processor, the cable headend 208 prepares the program signals that are received by the cable headend 208 for transmission to each set top terminal 220.

As a network controller, the cable headend 208 performs the system control functions for the system. The primary function of the network controller is to manage the configuration of the set top terminals 220 and process signals received from the set top terminals 220.

The delivery system 200 and digital compression of the preferred embodiment provides a one-way path from the operations center 202 to the cable headend 208.

The set top terminal 220 is the portion of the delivery system 200 that resides in the home of a subscriber. The set top terminal 220 may be a stand alone unit or may be integrated into a presentation device (e.g., a television) or as part of a computer.

The set top terminal 220 has a plurality of input and output ports to enable it to communicate with other local and remote devices. The set top terminal 220 has an input port that receives information from the cable headend 208. In addition, the unit has at least one output port which provide communications from the set top terminal 220 to a television. Also, the set top terminal 220 contains a phone jack which can be used for maintenance, trouble shooting, reprogramming and additional customer features. The set top terminal 220 may also contain stereo/audio output terminals, a satellite dish input port and/or microphone and camera input ports for supporting video calls.

Functionally, the set top terminal 220 is the last component in the delivery system chain. The set top terminal 220 receives compressed program and control signals from the cable headend 208. After the set top terminal 220 receives the individually compressed program and control signals, the signals are demultiplexed, decompressed, converted to analog signals (if necessary) and either placed in local storage (from which the menu template may be created), executed immediately, or sent directly to the television screen.

If the subscriber selects a specific program from a menu, the set top terminal 220 determines on which channel the program is being shown, demultiplexes and extracts the single channel transmitted from the cable headend 208. The set top terminal 220 then decompresses the channel and, if necessary, converts the program signal to an analog NTSC signal to enable the subscriber to view the selected program. The set top terminal 220 can be equipped to decompress more than one program signal, but this would unnecessarily add to the cost of the unit since a subscriber will generally only view one program at a time. However, two or three decompressors may be desirable to provide picture-on-picture capability, control signal decompression, enhanced channel switching or like features.

The primary conduit for communication between the subscriber and the set top terminal 220 is through the subscriber interface, preferably a remote control device. Through this interface, the subscriber may select desired programming through the system's menu-driven scheme or by directly accessing a specific channel by entering the actual channel number. Using the interface, the subscriber can navigate through a series of informative program selection menus. By using menu-driven, iconic or alpha-character access, the subscriber can access desired programs by simply pressing a single button rather than recalling from memory and pressing the actual channel number to make a selection. The subscriber can access regular broadcast and basic cable television stations by using either the numeric keys on the remote control 900 (pressing the corresponding channel number), or one of the menu icon selection options.

The set top terminal 220 receives and manipulates signals from the cable headend 208. The set top terminal 220 is equipped with local computer memory and the capability of interpreting the digitally compressed signal to produce menus for the subscriber. The remote control 900 communicates the subscriber's selections to the set top terminal 220. The subscriber's selections are generally based upon menus or other prompts displayed on the presentation device.

It is preferred that the signal reaches the subscriber's home in a compressed format and is decompressed prior to viewing. Included in the delivered program signal is information that enables equipment at the subscriber's home to display menus for choosing particular programs. Depending on the particular embodiment, the television program signal may arrive at the subscriber's home through one or more connections such as coaxial cables, fiber cables, twisted pairs, cellular telephone connections, or personal communications network (PCN) hookups.

The program control information signal is generated by the operations center 202 and provides the network controller 214 with data on the scheduling and description of programs. In an alternate configuration, this data is sent directly to the set top terminal 220 for display to the subscriber.

Within the context of a telephony application such as a voice-over IP application, subscriber premises may also include (in addition to one or more set top terminals 220 and their associated presentation/display device 800 and remote control devices 900) a cable modem 230, a router or MTA 240, and a local area network (LAN) or a direct connection between the router 240 and set top terminal(s) 220. Thus, if a set top terminal 220 does not have a built-in cable modem or other means of interacting with an IP network, an external cable modem may be coupled to the set top terminal either directly or via a local area network using a router or MTA. In this manner, multiple set top terminals 220 may act as respective extensions within a household telephone system. Interaction by users or viewers with the set top terminals 220 or a telephone 240 (operatively coupled to the router 240 or LAN 250) may be displayed using presentation or display device 800 of the set top terminals (or a built-in display device on the telephone 245).

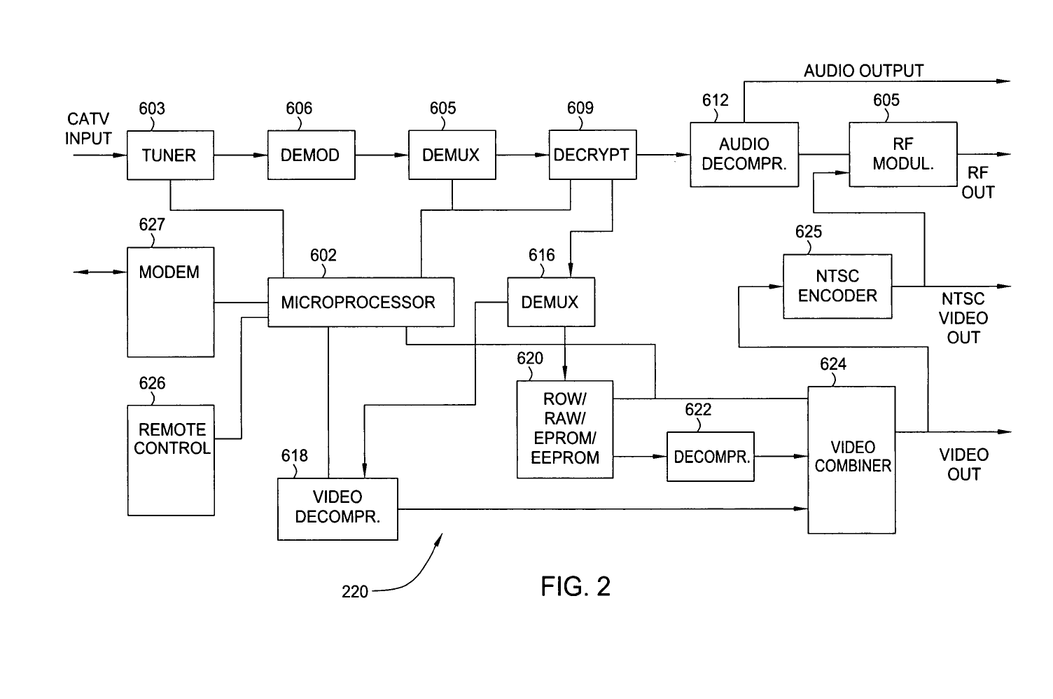

FIG. 2 depicts a high level block diagram of a set top terminal (STT) suitable for use in the television delivery system of FIG. 1. The set top terminal 220 has a tuner 603, digital demodulator 606, decryptor 600, and demultiplexers 609,616 as well as audio equipment 612 and a remote control interface 626 for receiving and processing signals from the remote control unit 900. An optional modem 627 allows communication between a microprocessor 602 and the cable headend 208 via a high speed internet (HSI) network. An NTSC encoder 625 provides a standard NTSC video output (other encoder may be used).

The microprocessor 602 is capable of executing program instructions stored in memory. These instructions allow a user to access various menus by making selections on the remote control 900. To support video calling, the instructions also enable the microprocessor 602 to process video signals from a camera, to process audio signals from a microphone and to control a camera and microphone. The microprocessor 602 may be a single microprocessor, as shown, or may be several microprocessors, such as a general microprocessor, a camera microprocessor and a microphone processor.

The manner in which the video is decompressed and the menus are generated from the program control information signal or STTCIS varies depending on the specific embodiment of the invention. Video decompressors 618 and 622 may be used if the video is compressed. The program control information signal may be demultiplexed into its component parts, and a video decompressor 618, graphic decompressor, text generator and video combiner 624 may be used to assist in creating the menus.

In addition to the menu format information that is stored in graphics memory, the set top terminal 220 also stores data, tracking those programs that have been selected for viewing. By gathering this data, the set top terminal 220 can maintain an accurate record of all programs accessed/watched by storing the data in EEPROM or RAM. Subsequently, this data can be transmitted to the cable headend 208, where it can be used in carrying out network control and monitoring functions. Such data transmissions between the set top terminal 220 and cable headend 208 can be accomplished, for example, through upstream transmission over the cable network (e.g., via an upstream IP link) or over telephone lines through the use of telephone modems.

The set top terminal 220 generates and creates menus using, in part, information stored in its graphics memory. A background graphics file stores menu backgrounds and a logo graphics file stores any necessary logos. A menu display and cursor graphics file will store menu display blocks and cursor highlight overlays as well as any other miscellaneous files needed to build the menus. Using this method of storing menus, the menus can be changed by reprogramming the graphics memory of the set top terminal 220 through instructions from either the network controller or operations center 202.

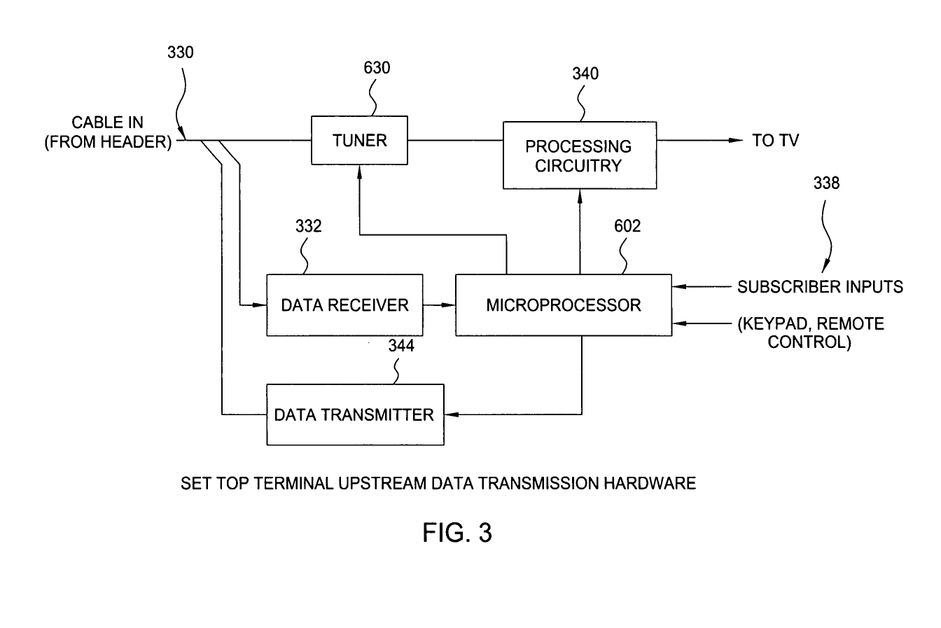

FIG. 3 depicts a high level block diagram of a portion of an STT adapted to provide bi-directional communications. Specifically, FIG. 3 shows a preferred set top terminal 220 that includes a data receiver 332 and a data transmitter 344. The data transmitter 344 provides upstream data communications capability between the set top terminal 220 and the cable headend 208. In a preferred embodiment, the upstream data communications capability comprises an internet protocol (IP) network, such as a cable television high speed internet link between the set top box and the head end.

Data targeted to individual set top terminals 220 is received by the data receiver 332 according to each set top terminal's specific address or ID (e.g. set top ID 928,928′). Received data may include information regarding channels and programs available for selection services IP telephony calls and the like. The subscriber may enter a series of commands using the keypad 645 or remote control 900 in order to choose a channel or program or otherwise navigate a service such as a telephony service. Upon receipt of such commands, the set top terminal's microprocessor 602 instructs the tuner 603 to tune to the proper frequency of the channel or program desired and subsequently instructs the processing circuitry 340 to begin descrambling of this channel or program. In a telephony service, an incoming or outgoing call is processed according to call management functions discussed below.

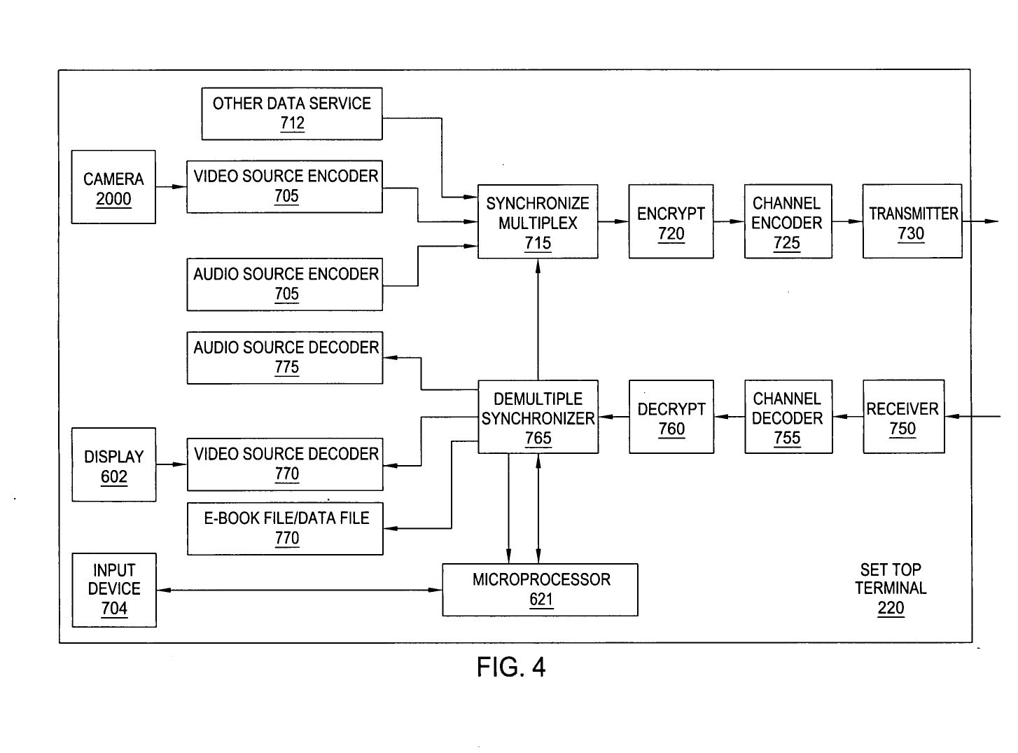

FIG. 4 depicts a high level block diagram of an STT modified to also include video calling capabilities. Specifically, a form of the present invention provides video calling capability in the set top terminal 220. To support video calling, the set top terminal 220 is augmented with additional features, such as shown in FIG. 4. The additional features can be integrated into an enhanced set top terminal 220 or provided as one or more upgrades to a more basic set top terminal 220. In FIG. 4, a camera 2000 and an input device 704 are included in the set top terminal 220. The camera 2000 is preferably a small video camera located and oriented on the set top terminal 220 so that it is typically directed at the face, torso, or entire body of one viewing the display 602. The direction of pointing is preferably manually adjustable by the user. Alternatively or additionally, the camera 2000 can be pointed, focused and otherwise controlled electronically.

The input device 704 performs the function of accepting user input in order to establish and manage a video call, e.g., entering party identifiers, hanging up, etc. The input device 704 may be a physical joined with the set top terminal 220 or apart from the set top terminal 220. Exemplary forms of the input device 704 include a telephone style number key pad; cursor/pointer movement device, such as a trackball, joystick or touch pad; click-type buttons; and a wired or wireless interface to a separate keyboard. Alternatively or additionally, the display device 222 and the input device 704 can be combined in the form of a touchscreen. The input device 704 may be a combinations of several different forms, including the illustrative ones just mentioned. In a preferred embodiment, the input device 704 is the remote control 900.

Video calling also requires an upstream (or reverse path or transmission) communication capability of sufficient bandwidth. The upstream communication capability for video calling is in addition to the downstream communication capability by which broadcast programming is received. The communications network that provides this bidirectional bandwidth is described in detail further below.

To support video calling, an instruction memory of the set top terminal 220 preferably contains programs for call establishment and management. The programs provide menus and a graphical user interface for call initiation, adding a party to a conference call, accepting an incoming call, terminating a call, and setting up call characteristics as well as display and other output characteristics.

In regards to transmission, a video signal from the camera 2000 is subjected to source encoding (i.e., conversion to spectrally efficient or compressed digital form) by a video source encoder 705, and an audio signal from the speaker/microphone 2002 is subjected to source encoding by an audio source encoder 710. The source encoded video and audio signals are synchronized and multiplexed together by a synchronizer multiplexer 715. The video source encoder 705, audio source encoder 710 and the synchronizer multiplexer 715 together can function to perform standard audio/visual encoding algorithms such as MPEG (motion picture expert group) or ITU standard H. 261 or H. 263, which are well known in the art. Other media signals, signals containing signaling information or data signals from a data source 712 can also be multiplexed with the audio and video signals, as described in greater detail below. The multiplexed audio/visual signal output from the synchronizer multiplexer 715 is optionally encrypted by an encryptor 720 and channel encoded (e.g., forward error correction encoding and/or interleaving) by a channel encoder 725 before being transmitted by a transmitter 730 upstream into a video conferencing connection network. Those skilled in the art will appreciate that the transmission functions illustrated in FIG. 30 can be implemented in an order different from that illustrated.

In regards to reception, an incoming (i.e., downstream) video conferencing signal is received by a receiver 750, decoded by a channel decoder 755, decrypted by a decryptor 760, and demutliplexed with proper relative timing among video, audio and other data components by a demultiplexer synchronizer 765. Video signals are decompressed by a video source decoder 770 and output for display on a display device 602, which is typically the television 222 or other presentation device. Audio signals are decompressed by an audio source decoder 775 and output for playing on the speaker/microphone 2002, the speaker portion of which may be the speaker (s) of the television 222 Data files, such as electronic books, are stored in one or more files 777. Again, the order of processing can be different from that illustrated.

The other signals that can be multiplexed with the audio and video conference call signals include, for example, data files, electronic books, or HTML (hyper-text markup language) based content according to the ATVEF (advanced television enhancement forum) specification. The HTML content may be displayed, may be stored in the set top terminal 220 for later use, or may be passed to other devices. Broadcast data triggers, announcements, and content resources can be sent in the VBI of the video call signal or in an auxiliary data channel delivered with the video call signal. Announcements can be used to indicate that interactive programming content is available for a given video call or segment of a video call. Content resources contain the actual content or programming to be run on the receiving device. Such content includes Web pages, scripts and images. The broadcast data trigger is used to synchronize the initiation of the interactive programming content to an ongoing video conference call.

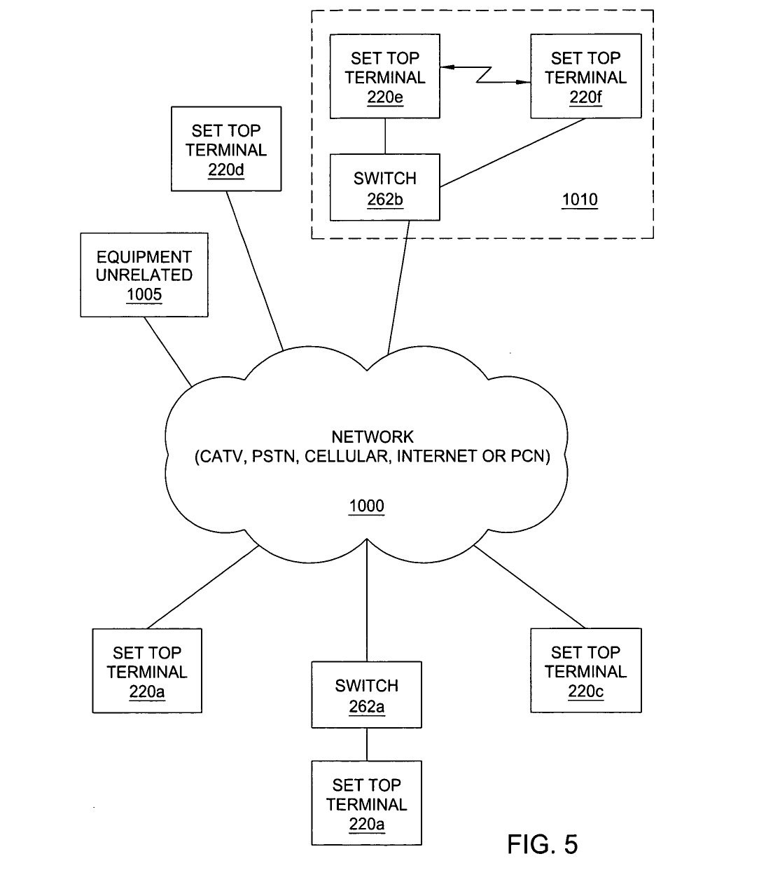

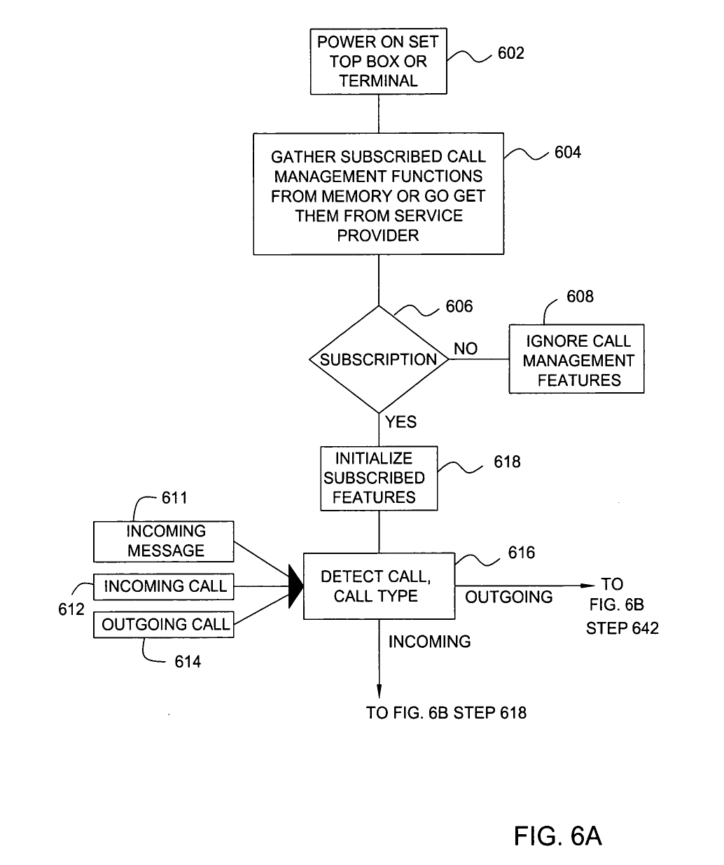

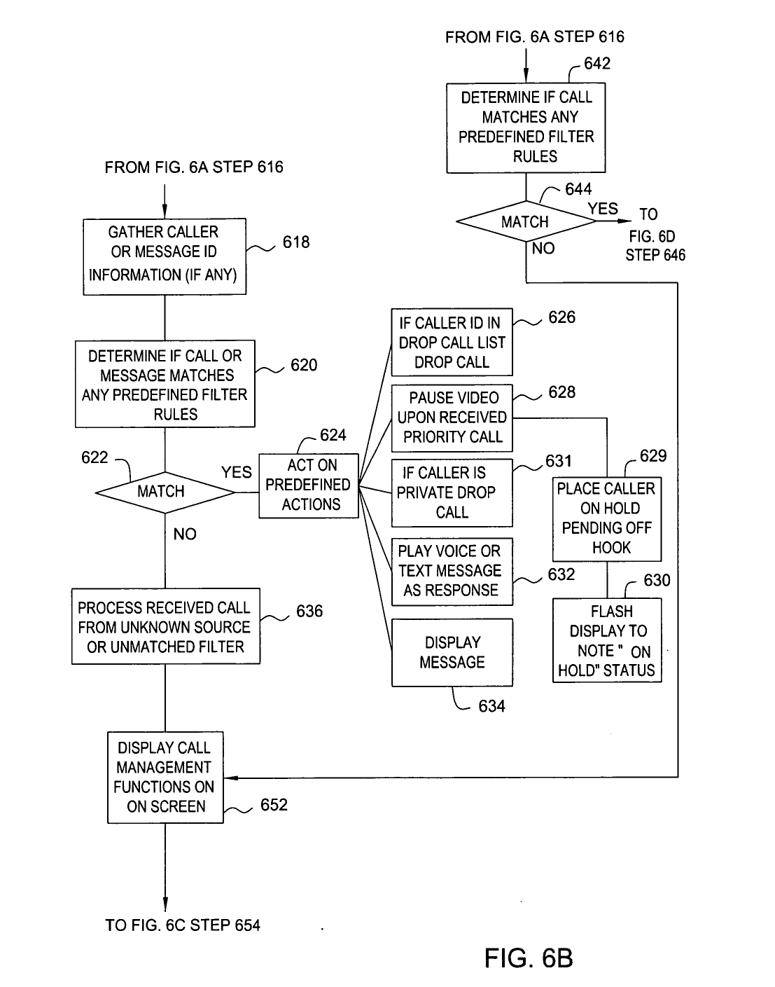

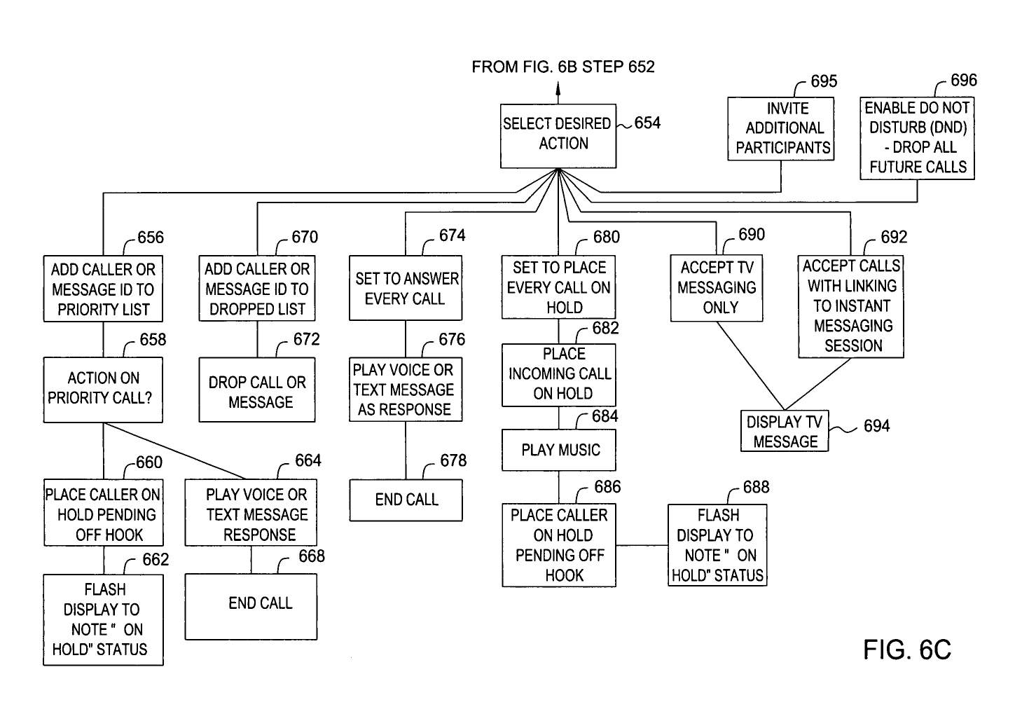

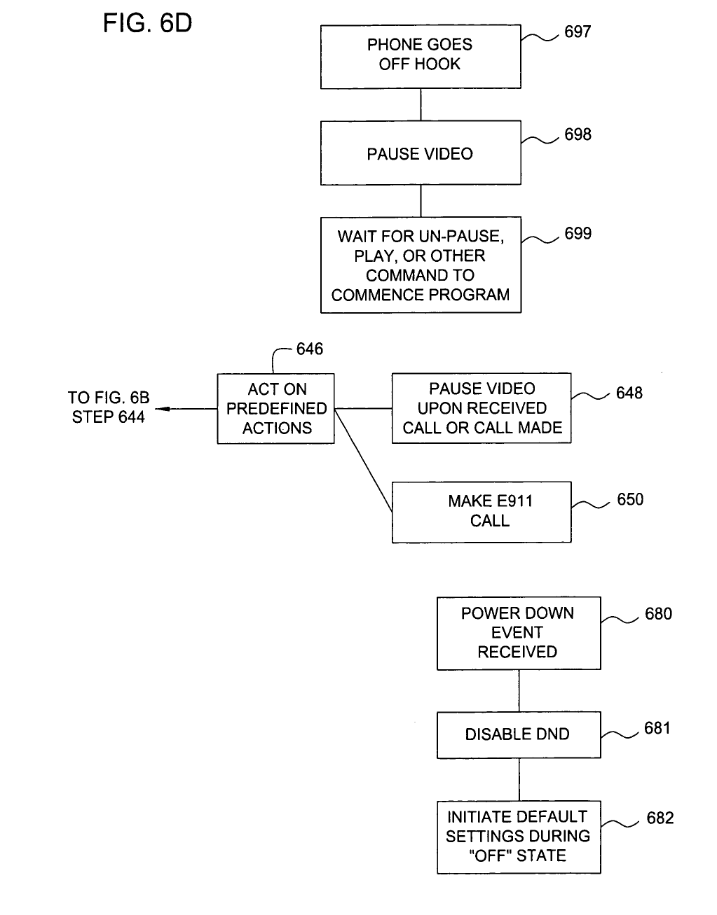

FIG. 5 depicts a graphical representation of various video conferencing network connections. Specifically, FIG. 5 illustrates a network 1000 in which video calling and/or telephony applications are supported between a plurality of devices, such as set top terminals 220, telephones 245 (e.g., via a cable modem 230) and so on. The network 1000 is depicted as being connected to a first switch 262A, which in turn is connected to a first STT 220A. The network 1000 is also connected to a second switch 262B, which is in turn connected to set top terminals 220E and 220F. Set top terminals 220E and 220F are also coupled to each other via a network, direct link, infrared link, wireless link or other means. The network 1000 is also depicted as being coupled to set top terminals 220B, 220C and 220D, as well as unrelated equipment 1005. The network 1000 is also depicted as being connected to a cable modem 230, which in turn is coupled to a router 240. The router 240 is coupled to a set top terminal 220K and a telephone 245. Within the context of an internet telephony application, voice-over IP communications are utilized to provide calling functionality between the various elements described herein. Moreover, the call management functions described in more detail below with respect to FIG. 6 may be implemented with any of the set top terminals 220, telephone 245, and telephony-enabled unrelated equipment 1005.

In one embodiment, the network 1000 utilizes a cable television transmission network, as described in section A above. Generally, a cable television transmission network comprises headends, each of which serves a number of subscribers. The connection between a headend and a subscriber may be metallic coaxial cable, optical fiber, or a hybrid, e.g., hybrid fiber-coax (HFC) systems. The most common cable networks today are HFC networks, but 100% fiber optic networks, i.e., fiber to the curb (FTTC), will be more prevalent in the future.

The extent to which bidirectional communication capability is present in the cable television system determines the support for calling between set top terminals 220. In one embodiment, a central node within the network 1000 performs signal processing and coordination to establish and manage a multiparty video conference call, as described in greater detail below. A video conferencing central node may be combined or collocated with other equipment in the cable television network. For example, a central node may be associated with an operations center to provide national or regional coverage. A smaller scope of coverage may be supported by a central node associated with a headend. An even smaller scope of coverage may be supported by a central node associated with a fiber node. Continuing one step further, the mini-network, as described above, results when a central node is associated with a local switch.

The cellular telephony system is a bidirectional communication network that can be utilized for calls between set top terminals 220 having cellular transceivers. Analog and digital cellular telephony systems are well known in the art and easily support two-party conference calls without video. Digital cellular systems are preferred for use with the present invention, because they offer greater bandwidth, which is necessary for transmission of video. A central node for video conferencing in a cellular network may be a cellular base station (i.e., at the center of a cell) or mobile switching station, which links many base stations together.

A wireless PCS (personal communication system) is another bidirectional communication network that is well known in the art and can be utilized for calls between set top terminals 220 having PCS transceivers. The PCS may be, for example, a PCN.

The PSTN (public switched telephone network) can be utilized with the present invention to communicate video conferencing calls among set top terminals 220 having a PSTN interface. The PSTN reaches worldwide and encompasses landlines (both metallic and fiber optic), terrestrial microwave links, and satellite links, as well as a large number of switching centers and exchanges. The PSTN is well known in the art, and in particular, multiparty conference calling in the PSTN is well known. Furthermore, schemes for video transmission via the PSTN are known in the art. For example, U.S. Pat. No. 5,563,882 (the '882 patent), which is hereby incorporated by reference in its entirety, discloses a video conferencing system that utilizes ISDN (integrated services digital network) and the H. 320 video telephone protocol. The '882 patent discloses a “multipoint control unit (MCU),” which is an example of a video conferencing central node, as used herein.

Hybrids of cable television networks, cellular telephony networks, PCNs, the PSTN, and other networks, such as the Internet, are possible. By way of example, some cable television networks presently provide interconnection to the PSTN and the Internet, so that a television cable can be the single communications conduit for a home or office. Further integration and interconnections to PCNs and/or cellular networks is technically straightforward and likely in the future.

A set top terminal 220 performs signal processing associated with the transmission and reception of call content. In regards to transmission, the audio signal sensed by the speaker/microphone 2002 is converted to digital form and compressed. For voice or speech audio, the following families of algorithms are particularly suitable: pulse code modulation (PCM), delta modulation (DM) and linear predictive coding (LPC). Each of the above families of algorithms includes variations, such as differential and adaptive variations. Similarly, the video signal sensed by the camera 2000 is converted to digital form and compressed. The fundamental techniques for image compression include vector quantization, discrete cosine transforms, and run-length encoding. Combinations of these techniques are also possible. For video sequences of images, interframe encoding based on motion prediction can be applied to provide further compression gains. These techniques as well as others are utilized in standard video compression algorithms, including low-rate MPEG and ITU standard H 261 and H. 263 for video conferencing, which are well known in the art. Any compression algorithm that produces acceptably low bit rates for video and/or audio transmission through the network and can be implemented in real time with acceptably small delay is suitable for use with the present invention. Encoding of video and audio may be distinct or interrelated. By way of example, MPEG is a combined standard for both video and audio.

In regards to reception, a set top terminal 220 executes a decompression algorithm corresponding to the compression algorithm. In addition, the set top terminal 220 may perform additional processing of the received signals. For example, the set top terminal 220 can deselect some or all other conference call participants for output on that particular set top terminal 220, scale video images, overlap video images, and otherwise customize the display and output characteristics. Furthermore, the set top terminal 220 may be programmed to automatically select the dominant speaker on the basis of the audio components of the conference call and enlarge the size and/or display resolution of the corresponding video output. These and other reception signal processing features are disclosed in, for example, U.S. Pat. No. 5,801,756, which is hereby incorporated by reference in its entirety.

A receiving set top terminal 220 with sufficient memory can record a call in its entirety or selected components of a call, including one's own audio, video, or other components. The ability to store and later retrieve calls or call components is useful for record keeping, recollection or message delivery. The record function can be programmed to operate without a human user present at the receiving set top terminal 220. In this case, the record function provides the set top terminal 220 with the capability of an answering machine or voice mail system with video and/or other media embodiments. By way of illustration of this capability, an unattended set top terminal 220 may receive a video call from a calling party. The unattended set top terminal 220 answers the call automatically and transmits an audio/video greeting to the calling party. In response to the greeting, the calling party transmits an audio/video message to the unattended set top terminal 220, which records the message.

A receiving set top terminal 220 can also convert an audio message to text in accordance with algorithms (e.g., voice recognition) that are well known in the art. The resulting text file can be displayed on the display 602 of the set top terminal 220 or stored in memory, within the set top terminal 220. This feature is useful to produce a transcript of a call or to “listen” to a call or message silently. The same speech to text conversion capability can be utilized with outgoing calls or messages as well. By way of example, a user may choose to transmit her audio signal as a text stream in place of or in addition to her audio signal. The set top terminal 220 can also be programmed to convert text to speech in accordance with well known algorithms. Such a feature is useful for users who have difficulty seeing or reading. Additional details of conversion between speech and text are provided in the above-cited application Ser. No. 09/344,449.

For a set top terminal receiving an incoming video call over the PSTN, cellular telephony or PCS networks, various caller identification techniques are applicable. For a set top terminal receiving an incoming video call over a cable television network, the caller identification data is preferably embedded in a vertical blanking interval (VBI) or program control information signal (PCIS), as described in earlier sections. For a set top terminal receiving an incoming video call over a cable television network, the caller identification data is preferably contained in a TCP/IP (transmission control protocol/Internet protocol) packet preceding the call packets. Preferably, the caller identification data is transmitted over the same network as the call itself, but this need not be the case.

FIGS. 6A-6D together depict a flow diagram of a method according to an embodiment of the invention. Specifically, the method 600 of FIG. 6 provides a call or communication management functionality to, illustratively, a set top box or terminal. While primarily described within the context of a set top box, it is noted that the call management functionality may be included within a stand-alone device, such as a set top terminal, a digital telephone, a Voice over IP (VoIP) device and the like. The call management functionality may also be integrated into a display device such as a television or other presentation device, or added to a device as a hardware, firmware or software upgrade module.

At step 602, a power on condition of the set top box or terminal is established. At step 604, the subscribed-to core management functions are gathered from memory or from a service provider. The subscriber selection may be automatically obtained as part of a periodic or automatic subscription refresh, or obtained forceably via a triggering of the set top box or terminal by a service provider.

At step 606, a determination is made as to whether subscription recall management functions exists. If no such subscription exists (or such functions are not enabled), then call management features are ignored at step 608 and the method is exited to await the next incoming or outgoing call. If the subscription does exist, then the subscription features are enabled at step 610. It is noted that such initialization may process global on/off features as well follow-on handling of other selectable features. Thus, steps 604-610 are associated with the establishment of a call management feature set, where the feature set defines functions associated with a call management function.

At step 616, one of an incoming message 611, incoming call 612 or an outgoing call 614 is detected. If an outgoing call, the method 600 proceeds to step 642. If an incoming call or message, the method 600 proceeds to step 618.

At step 642, it is determined whether the outgoing call matches any predefined filter rules. Such filter rules may comprise, illustratively, acting upon all outgoing calls, all incoming calls and messages, all known callers (CID Present), all private callers (Privacy Enabled), all callers and messages matching priority identifications saved, all callers and messages matching blocked identifications saved, all callers and messages with unknown identifications (neither blocked nor priority) or other filter rules. Specifically, a filter rule can be acted upon single caller (in the case of selecting an individual phone or message identifier) or it can be acted upon a wider population such as defined groups within the filter rules. Groups optionally include one or more of all outgoing calls, all incoming calls or messages, all known callers or message ids, all private or callers or messages, all callers matching priority ids saved, all callers or messages matching blocked ids saved, all callers or messages with unknown ids (neither blocked or priority).

If there is a match of filter rules (644), then the method 600 proceeds to step 646, where predefined actions associated with the filter rules are acted upon. Such predefined actions may comprise, illustratively, pausing video upon either of an incoming call or outgoing call 648, making an outgoing call to an emergency telephone number (e.g., an E911 call) 650 or other predefined actions. After acting on the predefined actions, the method 600 exits to await the next incoming or outgoing call. If there is no match of filter rules, then the method 600 proceeds to step 652 where corresponding call management functions are displayed in terms of an overlay object which may be transparent, translucent or opaque. Specifically, at step 652 call management functions are displayed as transparent or opaque active objects, or as part of a larger call features management menu such as a menu used to configure call management options.

A subscription of which call features are made available to the user is optionally handled in a number of different ways. One technique way is through the use of a common bitmask. Using a bit mask to include or exclude the availability of call features to the terminal could be accomplished similar to the following
00000000—empty set—no features active
00000001—Do not disturb feature
00000010—on hold feature
00000100—drop list handling feature
00001000—priority list handling feature

Using this bit mask technology, subscription information is passed down as either a binary string, a hexadecimal string, a character string, or an integer (e.g., with leading zeros added). A subscription activates one or more features simply by setting a one in the respective place holder of the bit mask and then AND-ing the bit mask with each feature to determine if it was active. In one embodiment of the invention, a hexadecimal string is passed which encrypts the above string into a smaller number of characters. For example “FFFF” corresponds to 16 binary features. The actual size of the hexadecimal number used could be much larger (e.g. contain many more than 4 characters) but for the purpose of this exercise only two are needed to explain the concept. The actual number of characters used would be a function of how many features need to be switched on or off via the subscription.

A subscription of “03” creates a binary string as follows “00000011” which in the example above would activate DND and the “on hold” feature when the subscription is AND-ed with these features, as follows:
00000011 AND 00000001=1=result DND activated
00000011 AND 00000010=1=result On hold feature activated

All features can be de-activated by sending a “00×16” or “00000000” binary to the terminal. When the terminal is reset the subscription is set by default to “00×16”.

In the case of an incoming call or message, the method 600 proceeds from step 616 to step 618, where caller ID information is gathered if available. Optionally, the call may be ignored if caller ID features are unavailable or if the caller has the privacy feature enabled on their telephone (i.e., anonymous call rejection or ACR). At step 620, a determination is made as to whether the incoming call matches any telephone number associated with an incoming filter rule.

If a match to an incoming filter rule is established at step 622, then at step 624 predefined actions associated with the matched rule are acted upon. For example, the predefined actions may comprise (1) dropping the incoming call if the caller ID is in a drop call list 626; (2) pausing video upon receiving the incoming call 628; (3) dropping the call if the caller is a private caller 631; (4) playing a voice or text message in response to the incoming call 632; (5) displaying on a television or other display device an instant message 634; or (6) some other predefined action associated with either the presence or absence of caller ID, or the specific caller ID presented. In the case of pausing video upon receiving a priority call 628, the caller is placed on hold pending an off-hook condition 629 (i.e., answering the phone), and a display is flashed to the user via the display device indicating that the caller is associated with an “on-hold” status 630.

If no match to an incoming filter rule is established at step 622, then at step 636 the received call is processed as being from an unknown source and/or unmatched filter rule. The method 600 then proceeds to step 652, where corresponding call management functions are displayed on a display device as previously indicated.

At step 654, the user selects a desired one of the displayed call management functions. Optionally, single remote key selection may be implemented to enable quick and easy selection without utilizing additional menu structures.

In a first call management function 656, the caller or message identification is added to a priority list. At step 658, a determination is made as to the appropriate action in response to the priority call. One action comprises, at step 660, placing the caller on hold pending an off-hook condition and, per step 662, flashing the user's display to note the “on hold” status of the caller. Another action comprises, at step 664, playing a voice or text message response to the caller or incoming message sender. Specifically, when a user detects that a priority call/message is received, the user has the option to select whether to answer the call/message or send the call/message to either a standard greeting (e.g. “I can't answer right now”) or voice mail. What ever option is selected, this action will set forth precedence for all future calls/messages from this caller id such that if caller is to be placed on hold pending answer, all future calls from that caller id will be similarly handled. Similar handling for those priority calls or messages directed to voicemail or greeting. After playing or otherwise distributing the text message, the call is terminated at step 668.

In a second call management function 670, the caller (via caller ID) is added to a dropped caller list, and the call is dropped at step 672.

In a third call management function 674, the system is set to answer every call and, at step 676, play a voice or text message in response to the call. Upon concluding the voice or text message, the call is ended at step 678.

In a fourth call management function 680, the incoming call is placed on hold 682, and music is played at step 684. The call remains on hold at step 686 pending an off-hook condition. At step 688, a display is flashed to note the “on-hold” status of the caller to the user.

In a fifth call management function 690, only TV instant messaging is accepted, such messaging being displayed to a user via a display device 694.

In a sixth call management function 692, only calls with links to instant messaging sessions are accepted, such messaging being displayed to a user via the display device 694.

In a seventh call management function 695, additional participants in the call are invited to join the call, thereby providing multi-party calling functionality.

In an eighth call management function 696, a do-not-disturb (DND) function is enabled, which function results in the dropping of all future calls until the DND is disabled by the user. Specifically, in the event the do not disturb function is engaged, all incoming calls will be either dropped or routed to voicemail or given a standard greeting. All non priority calls will be dropped. All priority calls will be sent to voicemail including those previously set to be placed on hold—thus DND will override preference for picking up such calls. However, when DND is disengaged (which happens automatically upon powering down the terminal), previous priority handing settings for each caller id will be restored.

At step 697, the telephone goes off-hook in response to a user picking up or otherwise enabling a hand set. In response, at step 698, the presently displayed video is paused until, at step 699, an un-pause play, play, or other command adapted to commence the video program is received. Specifically, upon the user being informed of having, for example, a priority incoming call placed on hold, the line will be monitored for the phone to go off-hook (i.e., for the user to engage with the on-hold caller via speaker phone, hand set, head set or the like). When the phone goes off-hook, the video program will be automatically paused. Un-pausing the video requires the user to interact with the terminal interface or the remote control.

In the event of reception of a power down event at step 680, the do not disturb (DND) function is disabled (if presently enabled) at step 681, and default settings are initiated during an “off” state at step 682. Specifically, the power down selection will additionally disengage the do not disturb (DND) function. As previously noted, all phone calls or messages received during the time that the DND is engaged will be either dropped or automatically answered via voice or text messaging as per any prior settings for automated handling of priority calls or messages.

The above-described methodology enables several actions to be taken in response to a received call. To summarize, programming being presented may be paused and a call answered automatically, the call may be dropped immediately, the call may be dropped immediately and added to a list of blocked numbers, a specific pre-recorded message or text message may be played to the calling party, a specific pre-recorded music track may be played to the calling party (e.g., while on hold), a specific pre-recorded message may be played to the calling party and future calls may be disabled, call management options may allow for priority calls only (where priority may be defined in terms of calling party, emergency calling and the like), a call management option may be set to accept “TV instant messaging only” or to accept calls with linking to instant messaging session, an E911 call may be made via a set top box or television device and/or additional participants may be invited to enable multi-party calling sessions.

Generally speaking, the various features associated with the present invention provide cable TV users with the capability to eliminate unwanted phone calls during TV viewing and, where phone calls are wanted, to process the wanted phone calls in a predefined manner such that important information or important received calls are appropriately presented to the user.

Various TV specific user alerts may be provided within the context of the present invention. Specific user alerts associated with the implementation of this feature include TV visual alert on/off, TV audio alert type, TV visual alert type, set response messages, auto setting(s) revert on TV power down (i.e., settings are changed at the TV's power off), TV/telephone settings begin “TOL” (settings are set relative to TV viewing schedule), TV PC and other electronic device (i.e., alerts may appear on other electronic devices; settings may be initiated on other electronic devices).

In one embodiment of the invention, a digital phone is increased in functionality by the integration of the features discussed herein with respect to the present invention. Such features include voice ringing on/off, distinctive ringing, call forwarding, block all calls, priority call setting, inviting additional phone participants and the like.

With respect to other electronic devices, additional communications techniques may be utilized within the context of the present invention. For example, PCs and other devices may communicate with the set top box via the internet (e.g., through various internet service providers), via a wireless link, via a home network and the like. Portable devices may communicate via infrared, blue tooth and/or other available communications means. These communications may be used to set various parameters of set top box (i.e., client device) operation, such as adding or deleting entries from a priority list, a drop list, enabling or disabling a do not disturb feature, associating custom rings with calling numbers and so on. Generally speaking, remote access of the client device or server storage of client device operating parameters may be used to adjust any of the features and operating parameters discussed herein. Operating parameters associated with a client device may be stored in the device, on a server or on another client device (e.g., a computer, telephone or other client device).

Advantageously, the present invention offers several compelling features. Such features include simultaneously call answer and TV pause using a remote control device, call management features accessed on a TV device, call management features integrated with TV services, emergency 911 calling via a TV application interface, emergency messaging via a TV application interface, a mixing of telephone audio and telephone alerts with video services, and the like.

In various embodiments, it is noted that an instant messaging application on a TV device is provided. Also, a user application bridging voice calls to an instant messaging session is also provided. Also provided is an optional resume call alert from a hold setting when a call is initiated.

Within the context of automatically pausing a television program in response to a phone call, a digital video recorder (DVR), or other recording device, operates to buffer the programming while the call is processed on behalf of the user and, if accepted by the user, during a conversation.

In one embodiment of the invention, a VoIP system is used. In this system, various type of information such as voice, messaging, email, MPEG encoded content and so on are provided using an IP architecture.

One embodiment of the invention is implemented as a program product for use with a computer system such as, for example, the client device or set top terminal processing system described herein. The program(s) of the program product defines functions of the invention embodiments and can be contained on a variety of signal/bearing media. Illustrative signal/bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The is latter embodiment specifically includes information downloaded from the Internet and other networks. Such signal-bearing media, when carrying computer-readable instructions that direct the functions of the present invention, represent embodiments of the present invention.

The terms and descriptions used herein are set forth by way of illustration only and are not meant as limitations. Those skilled in the art will recognize that numerous variations are possible within the spirit and scope of the invention as defined in the following claims.

What is claimed is:

1. A method for use in an content distribution system, the method comprising:
establishing a call management feature set, said feature set defining functions associated with a call management function;
applying a filter rule to a communication, said communication comprising one of an incoming call and an outgoing call;
in the case of said communication matching said filter rule, performing one or more actions corresponding to said matched filter rule;
wherein at least one of said actions comprises pausing a video presentation in response to said communication.

2. The method of claim 1, wherein a further said action comprises generating an emergency call.

3. The method of claim 1, wherein a further said action comprises dropping an incoming call where a caller identification of the incoming call is not available.

4. The method of claim 1, wherein a further said action comprises dropping an incoming call where a caller identification of the incoming call is associated with a drop call list.

5. The method of claim 1, wherein a further said action comprises, in response to an incoming call, performing one or more of playing a voice message, generating a text message and displaying an instant message.

6. The method of claim 1, further comprising:
in the case of said communication not matching a filter rule, displaying call management functions on a display device and waiting for a user selection of a call management function.

7. The method of claim 6, wherein said call management functions include:
dropping said communication if said communication does not comprise a priority call; and
playing one or both of a voice message and a text message if said communication does comprise a priority call.

8. The method of claim 6, wherein call management functions include:
adding an incoming caller identification to a drop call list and dropping the corresponding incoming call.

9. The method of claim 6, wherein call management functions include:
playing one or both of a voice message and a text message; and
disabling future calls.

10. The method of claim 6, wherein call management functions include:
placing an incoming call on hold and playing an audio message for the incoming caller.

11. The method of claim 6, wherein call management functions include:
accepting only instant messaging, such messaging being displayed via a display device.

12. The method of claim 6, wherein said call management functions include:
inviting additional participants to establish a multiple party call.

13. A system, comprising:
a head end within a content delivery system, said head end delivering content to each of a plurality of client devices, said head end supporting Voice over IP (VoIP) telephony services for said client devices via an internet protocol (IP) network; wherein
each of said client devices has associated with it a call management feature set for defining call management functions;
each of said client devices, in response to a respective communication event matching a filter rule, performing one or more actions corresponding to said matched filter rule, at least one of said actions comprising pausing a content presentation in response to said communication.

14. The system of claim 13, wherein:
said client devices comprise set top terminals response to respective remote control devices for enabling user interaction with said VoIP telephony service.

15. The system of claim 13, wherein:
said client devices further provide actions comprising at least one of generating an emergency call, dropping an incoming call where a caller identification of the incoming call is not available, dropping an incoming call where a caller identification of the incoming call is associated with a drop call list, playing a voice message in response to an incoming call, generating a text message in response to an incoming call and displaying an instant message in response to an incoming call.

16. Apparatus, comprising:
a client device adapted for communicating with a Voice over IP (VoIP) channel of a content delivery system;
the client device applying filter rules to incoming calls, incoming messages and outgoing calls, the client device responsively performing actions corresponding to matched filter rules, at least one of said actions comprising pausing a content presentation in response to said communication.

17. A computer program product, comprising a computer data signal embodied in a carrier wave having computer readable code embodied there in for causing a computer to perform a method comprising:
establishing a call management feature set, said feature set defining functions associated with a call management function;
applying a filter rule to a communication, said communication comprising one of an incoming call and an outgoing call;
in the case of said communication matching said filter rule, performing one or more actions corresponding to said matched filter rule;
wherein at least one of said actions comprises generating an emergency call.
